(19) United States
(12) Patent Application Publication
(10) Pub. No.: US 2003/0236120 A1
(43) Pub. Date: Dec. 25, 2003

(54) Method and device for determining the physical location and identity of a user

(76) Inventors: Kenneth Reece, Arroyo Grande, CA (US); Mette Reece, (US)

Correspondence Address: Mr. Kenneth Reece, 3689 Alisos Road, Arroyo Grande, CA, 93420, US

(21) Appl. No.: 10/418,846

(22) Filed: Apr. 18, 2003

Related U.S. Application Data
(60) Provisional application No. 60/374,225, filed on Apr. 19, 2002.

(51) Int. Cl. G06F 17/00

(52) U.S. Cl. 463/42

(57) ABSTRACT

A method and a device is described for determining the physical location and/or identity of network users and for preventing certain undesired users for participating in—or getting access to restricted activities, services or information. When a user accesses a service provider's website, an encrypted session ID is stored on the user's electronic device or computer. The user's electronic device or computer is then coupled to the service provider's server through a phone connection and the session ID is transferred to the service provider over the phone line for verification. By using Caller ID technology the user's telephone number is identified, and by analyzing the phone number the location of the player is determined. If the location satisfied the service provider's and any official regulator's requirements the available service options are then determined depending on the user's specific location. The available service options—if any—are then displayed on the user's electronic device or computer.

### CROSS-REFERENCE TO RELATED APPLICATION

This application is entitled to the benefit of U.S. Provisional Patent Application Ser. No. 60/374,225 filed Apr. 19, 2002.

### FEDERALLY SPONSORED RESEARCH

Not applicable

### SEQUENCE LISTING OR PROGRAM

Not applicable

### FIELD OF THE INVENTION

The present invention relates to a method and a device for restricting access to certain information and services based on a users identity, geographical location or age.

### BACKGROUND OF THE INVENTION

On Jun. 14, 2001, Nevada Governor Kenny C. Guinn signed into law Assembly Bill (A.B.) 466 and opened the door to a potential new frontier for gaming on the Internet. This legislation enables the Nevada Gaming Commission to adopt regulations upon the advice and assistance of the Nevada Gaming Control Board. However, before such regulations may be promulgated, the Legislature clearly instructed the Commission to first determine whether the related systems are secure and reliable and provide at least a reasonable level of assurance that players will be of a lawful age and that gambling will be available only in legal jurisdictions.

Although no federal legislation prevents lawful licensed Internet gaming, about half of the US states have laws that prohibits it citizens for making wagers, and as such a Nevada Internet Casino must be able to demonstrate that its gambling is not offered in these states.

Terminology

Electronic Device/Gaming Device

In the context of the present invention, the term “electronic device” is used to describe any electronic device, which can be used to receive and/or transmit information over a network. Such devices include, but are not limited to computers, PDAs, cell phones, telephones, televisions, set top boxes, satellite receivers, GPS devices, tablet PC's, gaming devices as described below and other electronic devices.

In the context of the present invention, the term “gaming device” is used to illustrate any electronic device, which can be used for gaming and/or gambling purposes. Such devices include, but are not limited to traditional gaming devices such as slot machines and video poker machines, home gaming devices as described in U.S. provisional patent application 60/326,785, Nintendo game devices, Playstation game devices, X-box game devices and other game devices.

The terms “electronic device” and “gaming device” are used interchangeably in this application, it being understood that the term “electronic device” also covers every conceivable gaming device and the term “gaming device” also covers every conceivable electronic device, which can be adapted to also function as a gaming device.

Game Provider/Service Provider/Information Provider

In the context of the present invention the term “game provider” is used to describe any person or entity, which is offering games and/or gambling activities.

Although the preferred embodiment of the present invention is used to restrict network access to gaming activities, the present invention can also be used to restrict network access to a number of non-gaming related services and/or activities.

In the context of the present invention, the term “game provider”, “service provider” and “information provider” is used interchangeably to describe any person or entity, which has a desire to restrict access to information or services based on the geographical location and/or age and/or identity of a user. It should be understood that the term “service provider” and “information provider” in the context of the present invention, also includes entities, which may not normally be considered to be neither a “service provider” nor an “information provider” in the traditional sense of those terms. For example governments or corporations who wishes to restrict access to information from certain citizens or employees, are considered “service providers” and “information providers” in the context of the present invention even though such entities may not be providing a service or normally be considered an “information provider”.

Biometric True Identity Information

In the context of the present invention the term “biometric true identity information” is used to describe biometric information which has been verified upon registration of a user. If for example a user is issued a smart card carrying biometric information such as a fingerprint information, and the users identity was verified at the time the fingerprint was captured, then this fingerprint is considered to be the users “biometric true identity information” in the context if the present invention.

Biometric Login-Information

In the context of the present invention, the term “Biometric login-information” is used to describe any biometric information which is captured at the time a user tries to get access to restricted information or services. For example if a user's fingerprint information is captured at the time of login (not to be confused with registration), this information is considered to be the “biometric login-information”.

Normally a user will only be granted access to a certain service or information, if there is a match between the “biometric login information”, which is captured at the time of login, and the “biometric true identity information”, which was captured—and verified—in a registration of the user preceding the users attempt to login.

Electronic Communication Device

In the context of the present invention the term “electronic communication device” is used to describe any electrical device which can be used for communication purposes. Such devices include—but are not limited to telephones, cellular phones, CBs, radios, walkie talkies and other electronic devices as described above, which can be used for communication purposes. The term “electronic communication device” is also used to describe other standard or proprietary communication devices which comprise means for transmitting and/or receiving data signals, both hard wired and wireless communication devices.

Receiving Device

In the context of the present invention the term “receiving device” is used to describe any electronic device which can be used to pick up data signals. Such devices include—but are not limited to cellular network antennas, other types of antennas, satellite receivers, any type of proprietary receiving devices and other types of receivers.

Caller ID Information

Most telephone operators provide a service which is called “Caller ID”. Normally the telephone number and in some cases more subscriber information is transmitted along with an outgoing telephone call, so that someone who is receiving a call can determine who is calling, prior to picking up the phone. Such Caller ID information can be used to determine the location of a caller, by analyzing the telephone number and determining in which area the telephone number is listed.

### DESCRIPTION OF PRIOR ART

When a person is browsing the Internet, there is no telling in which geographic location the person is physically present and so far no solution has been provided that ensures that a person is not gambling from an illegal jurisdiction.

A number of systems have been proposed to solve this problem. One suggestion has been to require that a player had a GPS navigator installed, which could determine a near exact location of the player. While this solution would certainly determine the location of the player, the cost involved in providing GPS navigators to all players makes it an unrealistic proposal.

Another proposed solution is to determine the physical location where the ISP through which a player connects to the Internet is based. While this solution in some cases conceivably could determine the location of a player, it would be very easy for a player in an illegal jurisdiction to connect to the Internet through an ISP in a legal jurisdiction, simply by calling up a different phone number.

Thus there remain a need for a solution that can determine the physical location of an online user, and block users from participating in activities that are illegal in the jurisdiction in which they are present.

### SUMMARY OF THE INVENTION

A method and a device is described for determining the location of an online user and for preventing users that are physically present in illegal jurisdictions from participating in activities that are illegal or undesired in that jurisdiction. The preferred embodiment of the invention relates to restricting a player from participating in a gaming activity over a network from a jurisdiction in which such gaming activity is illegal. Other embodiments of the invention are not related to gaming activities but can be used to determine the location of a user for other purposes, such as to determine sales tax on a purchase. The invention can also be used to restrict access to activities on a network, based on the age or identity of the user.

The preferred embodiment of the invention comprises the steps of:

a) requiring the player to attach his gaming device or computer to a telephone line.

b) dialing up a telephone number which is connected to a control system.

c) determining the telephone number from which the player is making the phone call by using caller ID technology.

d) performing a check to see if a player's telephone number is registered in an illegal or unwanted jurisdiction.

e) denying the player access to play a game if the player is in an illegal or unwanted jurisdiction or optionally if the phone call is made from an unregistered number or a number that has caller ID disabled.

f) optionally saving information regarding the player's gambling means (such as a registration code of a gaming device or a license number from a software gaming application).

One embodiment of the present invention comprises means for reading and/or writing information to an electronic storage media such as a smart card. U.S. Provisional Patent Applications 60/326785 (“Network gaming device”) and 60/330514 (“Mouse pad gaming device”) both by Kenneth Reece, describes devices and methods for using smart card technology with a network gaming device. Both applications are included herein in their entirety by reference.

### OBJECTS AND ADVANTAGES

It is an object of the present invention to provide a cost effective solution that allow online gambling providers to exclude undesired players from participating in their online gambling activities.

It is further an object of the present invention to restrict the selection of games that are made available to a player, to comply with local gaming regulations of the player's jurisdiction.

One advantage of the invention compared to other proposed solutions is, that it does not require the gaming provider to make unreasonable investments to satisfy legal concerns.

It is equally an advantage of the invention that it does not require the player to make any additional investments to satisfy gaming regulators concerns regarding the physical location of the player.

It is further a big advantage of the present invention that it allows a gambling provider, based on the location of the player, to customize the available game selection so it complies with the local gaming regulations of the player's jurisdiction. The state of California, for example, does not allow the placing of—or taking bets on 11 named games, including Roulette and 21. Poker however is legal in California, and by determining that a player is present in California, the selection of games available to the player can be limited to poker.

### DESCRIPTION OF THE DRAWING FIGURES

FIG. 1 is a simplified schematic illustration of a preferred embodiment of the present invention.

FIG. 2 is a simplified schematic illustration of an alternate embodiment of the present invention.

FIG. 3 is a simplified block diagram of the embodiment of the invention that is illustrated in FIG. 1.

FIG. 4 is a simplified schematic illustration of an alternate embodiment of the present invention.

FIG. 5 is a simplified schematic illustration of an alternate embodiment of the present invention.

FIG. 6 illustrates a game device of the prior art

FIG. 7 is a simplified schematic illustration of an alternate embodiment of the present invention.

FIG. 8 is a simplified schematic illustration of an alternate embodiment of the present invention.

FIG. 9 is a simplified schematic illustration of an alternate embodiment of the present invention.

### REFERENCE NUMERALS IN DRAWINGS

| | |
|---|---|
| 100 | Player's game device or computer or TV |
| 200 | Network such as the Internet |
| 300 | Game provider's server |
| 400 | Game provider's end of a phone connection |
| 500 | Player's end of a phone connection |
| 600 | Cell phone |
| 700 | Cell phone network antenna |
| 900 | Set top box |
| 1000 | Game device |
| 2000 | Optionally interchangeable top of the base of a game device 1000 |
| 3000 | Game control buttons |
| 4000 | Pull arm |
| 5000 | Card insertion slot |
| 6000 | Top of game device 1000 |
| 7000 | Display |
| 8000 | Loudspeaker |
| 9000 | Transmitter |

### DETAILED DESCRIPTION OF THE INVENTION

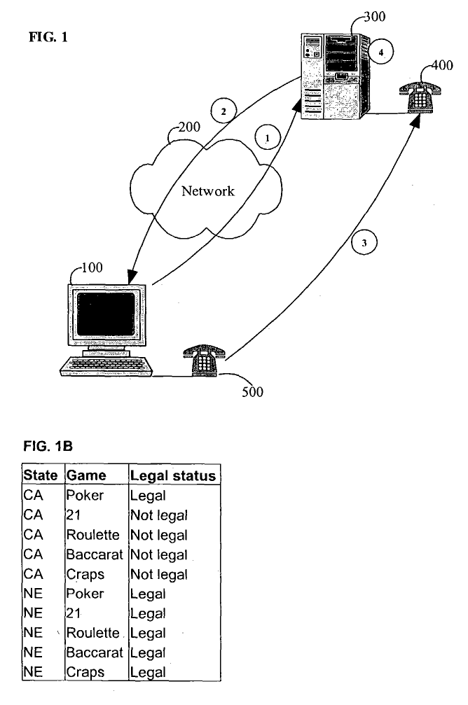

FIG. 1

FIG. 1 is an illustration of a system according to one embodiment of the present system. A player's game device or computer 100 is coupled to a game provider's server 300 over a network 200 such as the Internet. When a player connects to the server (1) the server issues an encrypted session ID that is stored on the game device or in the memory of the game device (2). After the session ID has been issued, the game device connects to the game server through a telephone line (3). When connection is established, the game device transmits the session ID to the game server, which verifies that the received session ID is still valid. The game server has now verified that the game device is connected to the same telephone line that is used to connect to the server, otherwise it would not be possible to transmit the encrypted session ID to the game server over the phone line. Using Caller ID technology the game server then determines in which jurisdiction the phone line (and the game device) is present (4), and based on the findings of this investigation the selection of legal gaming options, if any, is then presented to the player over the network. Optimally the player has a separate internet connection and phone line, but if not the lifespan of the session ID can be set to last through several disconnections, so that the system can be set to automatically switch between coupling the game device to the game server through the network and through the phone line.

FIG. 1B

FIG. 1B is an example of a database that the game provider can maintain to determine which games a player is allowed to play, once the geographic location of the player has been established. In the illustration the database is used to keep track of the legality of different games in different states. The database can optionally be set to a national countrywide level or a local citywide level. In the example, it is clear that the state of California permits the game of poker, but not other games such as roulette and 21. When a player is determined to be present in the state of California, he can then be restricted to playing the game of poker which is the only legal option for California.

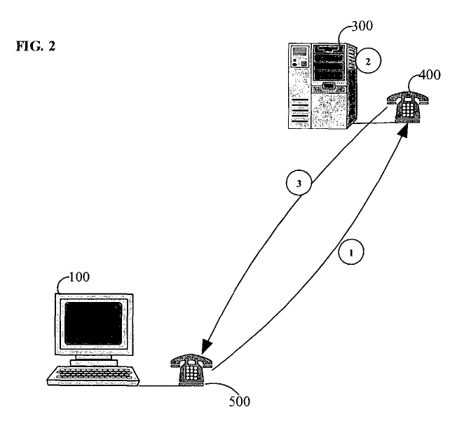

FIG. 2

FIG. 2 is an alternate embodiment of the present invention in which the entire communication between the player's game device and the game provider's server takes place over a telephone network. This will for example enable game providers to offer services to player's that do not have an Internet connection. In the illustrated embodiment the player's game device initiates a request to the game provider's server over a telephone line (Step 1). A location check is performed as described under FIG. 1 and it is determined which games should be provided to the player, as described under FIG. 1B (Step 2). A session ID can optionally be issued by the game server and provided to the game device (Step 3) for added security. The gambling can then take place using the communication link that is established between the player's game device (100) and the game provider's game server (300) through the telephone line.

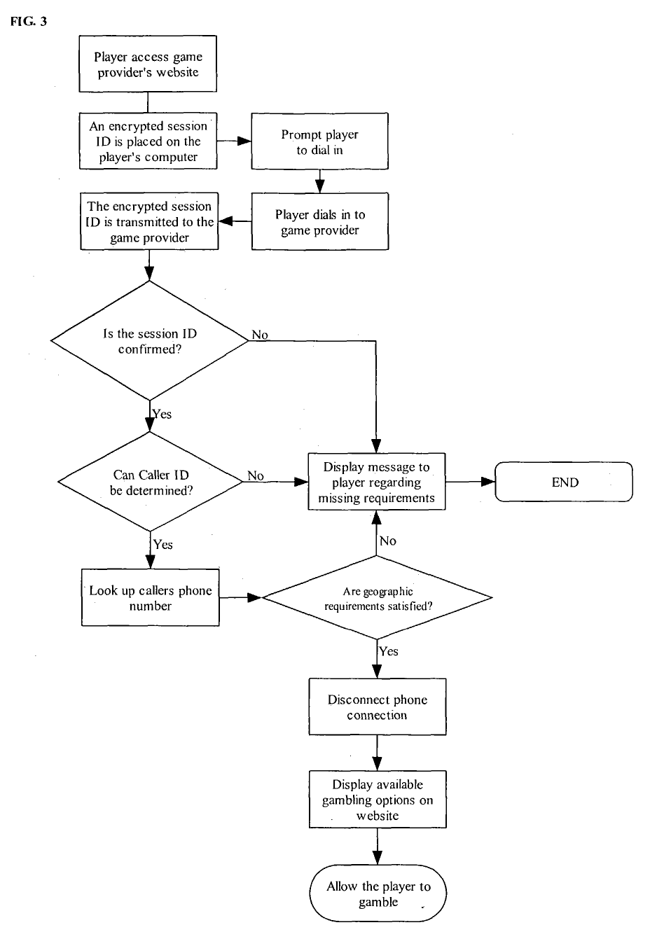

FIG. 3

FIG. 3. is a block diagram that illustrates the steps of a system according to one embodiment of the present invention, as further illustrated and described in and under FIG. 1.

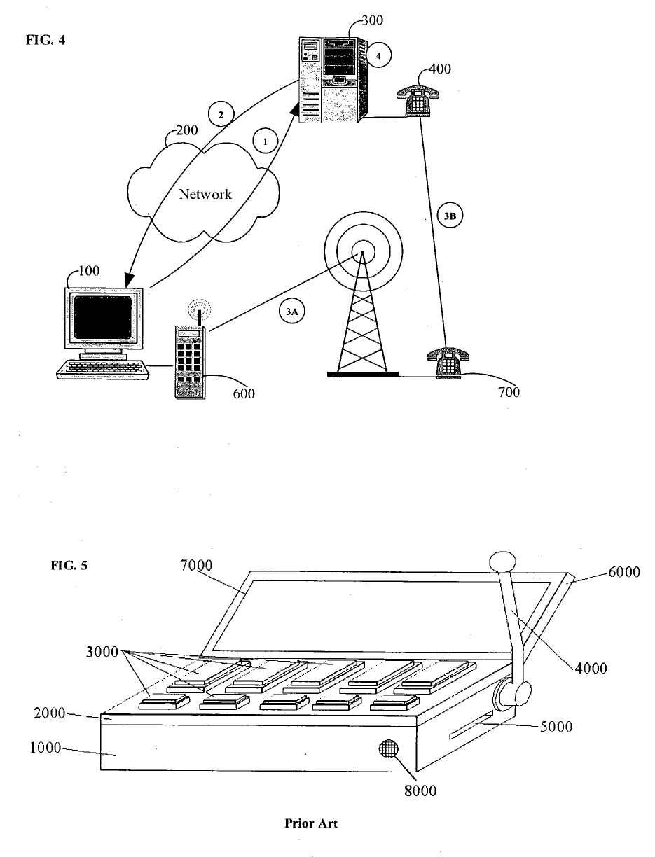

FIG. 4

FIG. 4 illustrates one embodiment of the present invention, in which a cell phone 600 is coupled to a user's game device, computer or TV 100. The user's game device, computer or TV 100 is coupled to a server 300 over a network 200 such as the Internet. When a user connects to the server (1) the server issues an encrypted session ID that is stored on the computer or game device or in the memory of the computer or game device (2). After the session ID has been issued, the device 100 connects to the server 300 through a cell phone 600 which is coupled to the device 100. The cell phone communicates wirelessly with a cell phone antenna 700 (3A) and the data is transmitted from the antenna 700 to the server 300 (3B). In FIG. 4 the communication of data from the antenna 700 to the server is illustrated as taking place over a phone line but it is noted that every means of communication can be used between the antenna and the server.

When connection is established, the session ID is transmitted to the server, which verifies that the received session ID is valid. The server 300 has now verified that the device which is connected to the cell phone 600, is the same device that was used to connect to the server, otherwise it would not be possible to transmit the encrypted session ID to the server using the cell phone.

The antenna that the cell phone transmits to, is always located within a small distance, and by determining what antenna on the cell phone network received the data from the cell phone, the location of the user can be determined fairly precisely. Often more than one antenna will pick up the signals from the cell phone, which makes it possible to determine the location of a user to a few hundred yards.

Law enforcement and emergency agencies are using different technologies to trace the location of a cell phone call, all of which can be adapted for use with different embodiments of the present invention.

FIG. 5

A game device of the prior art is illustrated in FIG. 5. The illustrated embodiment is adapted to function as a slot machine that can be played over a network, for example the Internet. The device can be adapted to play any game.

The device comprises means for coupling the gaming device to a game provider's server. The device further comprises means for displaying gaming information (7000), an optional pull arm (4000) for activating games, a plurality of control buttons (3000) to place bets, hold wheels, double bets etc., means for playing sound effects (8000). The top of the device (2000) is interchangeable and can be replaced by a user to easily adapt the device to play a plurality of different games.

After connecting the power, the player selects which game he wants to play and is then directed to a game provider's game server over a network.

The device comprises a card insertion slot (5000) in which a payment card can be inserted. The player uses the control buttons (3000) of the device to select the amount for each bet (for example 25 cents). Another button is used to control how many bets the player wants to place. The display constantly shows the player's current betting status (amount of each bet, number of bets placed and the total of all bets placed).

Using either at least one control button 3000 or the pull handle (4000) the player activates a spin after placing his bets.

When the player presses the “spin” button (or pull the optional handle 400), the total betting amount is instantly transferred from the players inserted stored value card (for example a smart card) to the game provider through the network connection.

After receiving the payment the game server selects the outcome of the spin and the result is displayed at the display (7000) of the gaming device.

When a player wins, the winnings are transferred to his card from the game provider.

The value on the stored value can either be “real” currency such as US dollars, but a game providers proprietary tokens can be used, or even points from different loyalty programs, depending on the arrangements the game provider makes. For example a casino can make a deal with a phone company to allow the stored value on the phone company's phone cards to be used as payment in the gaming device. Another example could be airline miles that could be stored on a card and used as payment. Any kind of electronically stored value can be used such as (for example) loyalty points, electronic coupons, electronic cash, proprietary token systems etc.

The body top 2000 is replaceable by a player to allow one gaming device to be used to play a plurality of games using different body tops 2000. A body top 2000 can also be adapted to be used to play a plurality of games, without the need to replace said body top.

A loudspeaker 8000 are used to play sounds that are normally associated with gaming machines, such as coins falling down to a tray when a pay out is made etc.

The pull handle 4000 is an optional feature players (or game providers) can attach to the device with the “look and feel” of a real slot machine. An identical functionality can be obtained using a control button 3000.

The payment system can be altered so that one amount is transferred from the smart card at the beginning of a gaming session, to a virtual “bank” that keep track of the results, and then updates the card when the player wants so sign off. If the player has won money, the original balance plus the winnings are transferred to the payment card, and if the player has lost money, the original balance minus the losses is transferred back to the card. The system will require less reading and writing to the card, but still provide instant placements of bets and a feeling of instant gratification of a winning player.

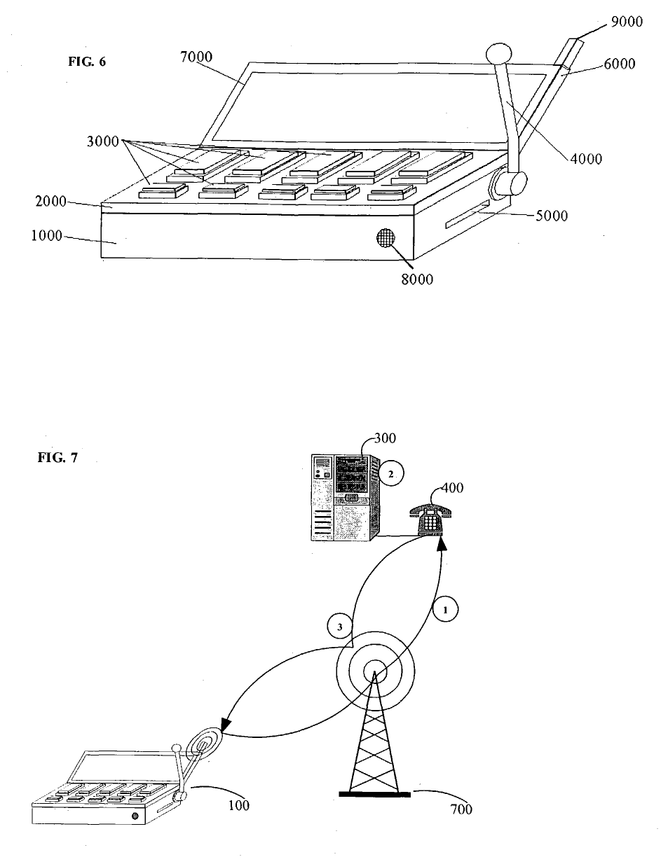

FIG. 6

FIG. 6 illustrates one embodiment of a gaming device of the present invention. The device has similar functionality as the game device described in FIG. 5, but it is further comprising means (9000) for wirelessly coupling said game device to a cell phone network antenna—or other antennas, to establish an approximate point of location of the game device. The device can further comprise cell phone technology so that a telephone number optionally can be entered manually. Said telephone capabilities can easily be connected to the loudspeaker of the device, conceivably giving the device capabilities of functioning as a conference call device as well. By comprising a web camera in the gaming device, the device can function as a video conference device or a web cast device. A camera comprised in the device can also be used by game provider's to perform head shape recognition, in order to single out unwanted players such as card counters.

FIG. 7

FIG. 7. is an alternate embodiment of FIG. 4, in which a game device according to one embodiment of the present invention comprises means for coupling said game device to an cell phone network antenna, in order to establish the location of said game device.

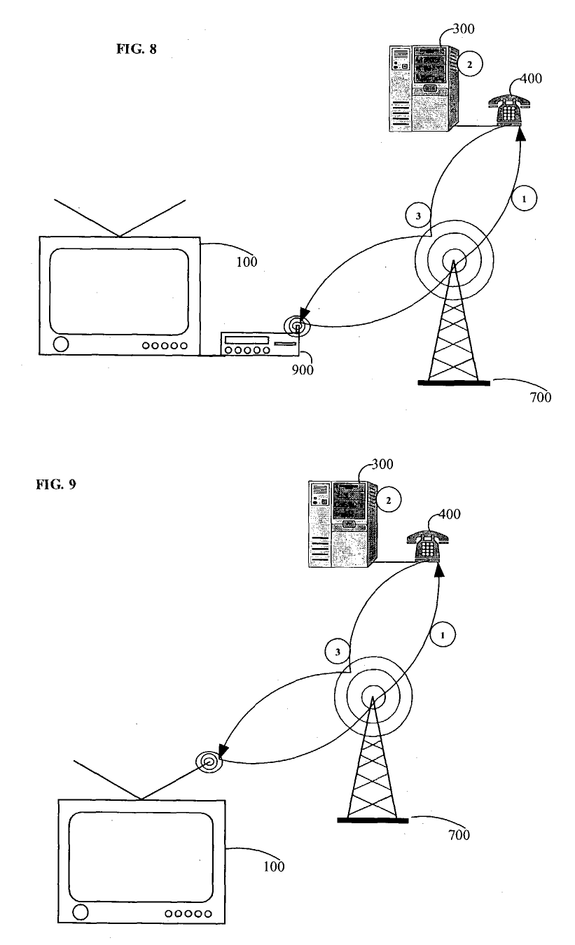

FIG. 8

FIG. 8 is an alternate embodiment of the present invention in which a TV is used to display game information and a set top box is used to couple the TV to the game provider, through a cell phone network antenna. A TV and/or a set top box can also be used as the game device of any other embodiment of the present invention.

Many set top boxes of the prior art already comprise a card insertion slot (such as those used for satellite TV) and as such a set top box can be used to transfer stored value to and from a payment card inserted into said set top box.

FIG. 9

FIG. 9 is an alternate embodiment of the present invention in which a TV functions as a game device, which is coupled to the game provider through an antenna which is coupled to the TV. Other embodiments of the invention utilizes other network connections than the one illustrated in FIG. 9 to couple the TV game device to the game provider.

Conclusion

It will be apparent to the reader that the present invention provides a solution to gaming regulator's requirements that game provider's ensure that no gambling is taking place in illegal jurisdictions. Not only does the present invention enable game provider's to comply with all regulatory concerns regarding the physical location of players, it provides a solution that is inexpensive for both players and game providers and it is simple to manage.

The foregoing Detailed Description is to be understood as being in every respect illustrative and exemplary, but not restrictive, and the scope of the invention should not be determined from the Detailed Description but rather from the claims of any regular patent application that is filed with reference to the present provisional patent application as interpreted according to the full breadth permitted by the patent laws.

Ramifications

In one alternate embodiment of the present invention, bets are made and optionally winnings are paid out by transferring funds to and from an electronic storage media such as a smart card, other types of cards or other types of electronic storage media. A read/write device is coupled to the player's game device or computer.

In another embodiment of the invention, the player's game device or computer can also comprise means for reading/scanning a player's ID card and/or personal biometric information such as fingerprint or iris information and transferring such ID or biometric information to the game provider for verification purposes. This optional feature will satisfy gaming regulator's desire to prevent underage persons to gamble over a network and it will provide the game provider with means to determine if an unwanted player tries to gamble. A web camera could conceivably be connected to—or integrated with the player's game device or computer to provide the game provider with a visual image of the player. Such an image can be run through an image database in a similar manner as security departments of live casinos are using head shape recognizing to spot card counters and other unwanted guests.

The verification of biometric information can also be made at the user side, by comparing the captured biometric information (such as a head shape) with information stored for example in a smart card, on a user's PC, in a gaming device, in a cell phone or any other conceivable means for digitally storing identification information. Such an embodiment is best illustrated with an example. In the following example a user's finger print information is stored in a smart card and verified from the user's home, it being understood that any biometric information can be used, which can be stored in any number of ways, which can be stationary or mobile.

### EXAMPLE

A user registers at a physical location to become an authorized online user. Upon registration the user's identity is verified by traditional means (passport, drivers license etc.). The user's biometric information, in this example a finger print, is recorded and stored, in this example, in a smart card, which is given to the user. Any user information, including the biometric information can optionally also be stored in a database for added security. When the user desires to get remote access to gamble over a network, the smart card is inserted into a read/write device and the user is requested to place his finger on a finger print sensor. Software in the smart card compares the stored finger print information, and if it matches the finger, which is placed on the fingerprint sensor, the user can be authorized to participate in the desired gambling activity. If it is required or desired to determine the physical location of the user, any method as described in the present invention can be used in combination with the present example. At the time of the filing of the present invention, finger print readers at the user side is not commonly known, but this will likely change over time.

The comparison between the stored biometric information and the captured information at the time of desired access, can take place on the user side using any number of verification techniques or by relaying the captured information to the game provider over a network, for remote verification.

Other devices such a web cameras are widely used, and a game provider can conceivably opt to do the user identity verification using a head shape image (or an algorithm calculated from such an image), which is transmitted over a network to a remote database. In this case the need to issue a smart card and a reader to the user would be eliminated, since the verification would not take place at the user side.

If it is desired to do the verification at the user end, but not desirable to issue a smart card or other means for the user to carry the user information around, the user's information can be stored in a database at the time of registration, and then transmitted to the user's computer or game device over a network, for example the first time the user tries to log in. The information can also be stored in the user's cell phone, either by transferring the information to the cell phone at the time of registration, or at a later time.

A special embodiment of the present invention can also be used to protect access to an operating system or certain software programs, by comparing captured head shape information at the time of login, with pre-stored true identity head shape information.

In yet another embodiment of the invention, the player connects to the game provider through another channel that provides a verifiable address, such as a TV cable network or a satellite connection. In this case the cable network provider or the satellite network provider verifies the player's address (or sometimes just the state of the player's location) as an alternative—or a supplement to using the described Caller ID method.

In yet another embodiment of the present invention, a TV set or a set top box can be adapted to function as the player's game device. Game information is displayed on the TV screen and bets are placed using a remote control.

Cell phone networks can also be used with the present invention to verify the location of a player. When any call is made from a cell phone the communication takes place via an antenna that is physically located within a few miles from the cell phone. Technology of the prior art describes how an exact location of a cell phone call can be determined. By using a cell phone as a game device or by comprising technology similar to cell phone technology in a game device or coupling a game device (or a computer) to a cell phone, the location from which the call is being made can be determined within a few hundred feet.

In another embodiment of the present invention, a cell phone can be adapted to function as the player's game device or authentication device. In one such embodiment the cell phone comprises means for displaying gaming information to the user. The cell phone further comprises means for capturing—and relaying to the game provider—biometric user identification information, such as fingerprint, head shape, or voice information—or non-biometric information such as social security number or a unique user ID number. Biometric information can be captured, for example by using a build in camera (head shape), a fingerprint sensor or a voice recording. Non biometric information can be stored on an internal memory module (such as a SIM card) or an external memory module, such as a smart card or other media types. Cell phones of the prior art show cell phones comprising a camera and means for relaying captured information over a network (for example Samsung SGH-V205 T-Mobile or NTT Docomo SO505i). NTT Docomo F505i has fingerprint authentication.

It should be noted that the game provider of course can opt to outsource one or all of the tasks involved in determining the location of a player and which games, if any, should be made available to said player. A few examples of companies that conceivably could provide such a service could be cable TV companies, cell phone network operators or a phone companies.

A game device of the present invention can also be equipped with means for reading biometric information, which can be used to determine the identity of a player, and specifically to check that a player is of legal age to participate in gambling activities. A game provider can require that people register in advance to be allowed to gamble. By requiring that a valid ID be presented upon registering, and storing the unique biometric information about a player, such as fingerprint, iris, voice or head shape information, the game provider can then validate the identity of any player that tries to play the game provider's games. When a player tries to log in to the game provider's server, the player can be requested to provide some sort of biometric identification, such as placing a finger on a fingerprint scanner, talking into a microphone or getting in front of a camera (such as a web cam). Using a web camera as an example, a web camera can be comprised in the device of the present invention, or a stand alone camera can be coupled to the player's game device or computer. When the player tries to log in, he must first put his face in front of the camera. An image—or an algorithm representing the unique features of the player's head is then send to the game provider who can use any head shape technology to look up the player in a database, to verify that the player has registered in advance and that he is of a legal age. A fingerprint reader coupled to the player's game device can work in a similar manner with the fingerprint image or a unique number representing the fingerprint being provided to the game provider for verification of the player's identity. Conceivably several game providers can share one common player database, so that players will only have to sign up once to be able to access games provided by different game provider's. If it is desired to avoid a database in which the identification is stored, said information can be stored on an electronic data storage media such as a smart card, and carried by the user.

Smart cards or other means for storing personal identification information can also be used with the present invention to verify a player's identity and age.

Scope

Various changes to the foregoing described and shown methods and devices and corresponding structures would now be evident to those skilled in the art. It is to be understood, however, that even though numerous characteristics and advantages of the present invention have been set forth in the foregoing description, together with details of the structure and function of some embodiments of the invention, the disclosure is illustrative only, and changes may be made in detail, especially in matters of shape, size, arrangement of parts, means of capturing information and means of relaying information between a user and a game provider within the principles of the invention to the full extent indicated by the broad general meaning of the terms in which the appended claims are expressed. Various modifications may be implemented by those skilled in the art without departing from the scope and spirit of the invention.

We claim:

1. A method for restricting access or participation over a network comprising:
providing coupling means for coupling a users electronic device to a service provider providing verification means for verifying the identity of said user

2. A method according to claim 1 further comprising
providing means to determine the geographical location of said user.

3. A method according to claim 2 further comprising
providing means to issue a unique session ID
providing means for transferring said unique session ID from said service provider to said user
providing means for transferring said unique session ID from said user to said service provider

4. A method according to claim 3 wherein said unique session ID is transferred from said user to said service provider using an electronic communication device.

5. A method according to claim 4 wherein said communication device is connected to a telephone land line.

6. A method according to claim 5 further comprising
providing means for providing to said service provider, Caller ID information related to said telephone land line which is used to transfer said unique session ID from said user to said service provider.

7. A method according to claim 4 wherein said communication device is a wireless device.

8. A method according to claim 4 wherein said communication device transmits signals to at least one receiving device at a known location.

9. A method according to claim 8 further comprising
providing means to determine the geographic location of said user, by determining which said at least one receiving device at a known location receives said signals which is transmitted from said users said communication device.

10. A method according to claim 1 further comprising
providing means for storing biometric true identity information about a user
providing means for capturing biometric login-information from the user at the time of login
providing means for comparing said biometric true identity information with said captured biometric login-information at the time of login

11. A method according to claim 10 further comprising
providing means for said service provider to verify the identity of said user when said biometric true identity matches said captured biometric login-information.

12. A method according to claim 10 said biometric information is selected from a group comprising:
information relating a user's fingerprints
information relating to a user's iris
information relating to a the user's head shape
information relating to a the user's voice
information relating to a the user's DNA
other biometric information relating to the user

13. A method according to claim 1 wherein data related to the identity of said user is stored in an electronic storage media selected from a group comprising:
Bar code card
CD-ROM
Citizen card
Compact Disc
Compact Flash card
Contact smart card
Contact-less smart card
DVD
Floppy disks
Hard disks
IC cards
Loyalty program card
Magnetic stripe card
Memory chip
Memory module
Memory stick
Mini disk
Payment card
PC cards
Phone card
RAM module
SIM cards
Smart Media card
Stored value card
Tapes
Zip disks
Access cards
Election cards
Electronic books
Identification cards
USB dongle
Other data storage media

14. A method for providing access to participate in network gaming activities comprising:
providing means for coupling a player's game device to a game provider
providing means for said game provider to verify the geographical location of the game device
providing means for said game provider to verify the identity of the player
providing means for said game provider to restrict certain players from participating in certain games based on the collected user information

15. A method according to claim 14 wherein said game device can also function as a device selected from the group comprising:
Home game devices
Computer's
PDA's
Cell phones
Telephones
Televisions
Set top boxes
Nintendo game devices
X-box game devices
Playstation game device
Other game devices

16. A method according to claim 15 wherein said game device is coupled to said game provider through a network selected from a group comprising:
The Internet
Other public communication networks
Telephone networks
Cell phone networks
Cable television networks
Other cable networks
Satellite television networks
Other satellite networks
Other television networks
Wireless networks
Fiber networks
AOL
Compuserve
Hotels' internal networks
Optical networks
Other private networks

17. A method according to claim 16 further comprising
determining which games the player's of a certain geographic area is allowed to participate in over said network;
allowing access only to games that are authorized in said geographic area

18. A claim according to claim 17 further comprising
broadcasting or transmitting gaming information to television sets of players in authorized geographical areas;

19. A method according to claim 18 further comprising:
providing means for controlling gaming activities with a remote control

20. A method according to claim 19 further comprising:
providing means for placing bets and/or receive winnings using said remote control

21. A method according to claim 19 wherein said remote control comprises a card read/write device.

22. A method according to claim 19 wherein said remote control comprises means for storing gaming and/or betting related information.

23. A method according to claim 19 wherein said remote control comprises means for storing electronic value units selected from a group comprising:
electronic cash
electronic gaming chips
electronic coupons
electronic tokens
other electronic stored value

24. A method according to claim 14 further comprising:
providing means for communicating game related results and information over a network;
providing means for placing bets and receiving winnings over a network

25. An electronic device for accessing information and services over a network comprising:
providing means for communicating with at least one communication device;
providing means for transmitting user information for identification purposes

26. A game device according to claim 25 wherein said user information relates to at least one type of information selected from a group comprising:
Geographical location information determined by Caller ID
Geographical location information determined by telephone number
Geographical location information determined by cable network subscriber information.
Geographical location information determined by satellite television subscriber information.
Geographical location information determined by the proximity to an antenna
Geographical location information determined by GPS coordinates
